(19) United States
(12) Patent Application Publication
(10) Pub. No.: US 2025/0111139 A1
(43) Pub. Date: Apr. 3, 2025

(54) DESIGN DOCUMENT GENERATION FROM TEXT

(71) Applicant: ADOBE INC., SAN JOSE, CA (US)

(72) Inventors: Ionut Mironicä, Bucharest (RO); Oliver Brdiczka, San Jose, CA (US); Ashutosh Sharma, Noida (IN); Anand Khanna, San Jose, CA (US); Stefan Daniel Dumitrescu, Betera, Valencia (SP); Nikolaos Vlassis, San Jose, CA (US); Alok Kumar Singh, Noida (IN)

(21) Appl. No.: 18/903,274

(22) Filed: Oct. 1, 2024

Related U.S. Application Data
(60) Provisional application No. 63/587,213, filed on Oct. 2, 2023.

(30) Foreign Application Priority Data
Oct. 2, 2023 (RO) A/00544/2023

(51) Int. Cl. G06F 40/186; G06F 40/40; G06T 11/60

(52) U.S. Cl. CPC G06F 40/186; G06F 40/40; G06T 11/60

(57) ABSTRACT

A method, apparatus, non-transitory computer readable medium, and system for generating a design document from a text prompt include obtaining a design prompt that describes a document type and selecting a design template for the document type based on the design prompt. An image generation model generates an image for the design template based on the design prompt and a design document is generated based on the design template. The design document has the document type and includes the image at a location indicated by the design template.

### CROSS-REFERENCE TO RELATED APPLICATIONS

This U.S. non-provisional application claims priority under 35 U.S.C. § 119 to U.S. Provisional Patent Application No. 63/587,213 filed on Oct. 2, 2023 in the United States Patent and Trademark Office, as well as to Romanian Patent Application A/00544/2023 filed on Oct. 2, 2023 in the State Office for Inventions and Trademarks (OSIM), the disclosures of which are incorporated by reference herein in their entirety.

### BACKGROUND

The following relates generally to design documents, and more specifically to design document from text. A design document is a layered document that includes text elements and image elements. Design documents are typically created by hand. A user operates a graphical user interface and finds or creates the individual elements, and then composes the design document by arranging the elements therein. In some cases, a creator begins from a design template. Creators may iteratively adjust and modify templates, tuning each element of the design—from the choice of images, the layout, the color scheme, to the style of text—to better match the purpose of the document.

### SUMMARY

Embodiments of the present inventive concepts include systems and methods for generating design documents from a text prompt. Embodiments include a design generation apparatus configured to receive a design prompt and encode it to produce an intent embedding. A filtering component retrieves a set of design templates based on the intent embedding. Additionally, embodiments curate text and image assets for the design document utilizing multiple generation models. An image generation model creates image content for the design template based on the design prompt.

In some embodiments, a prompt generation model creates image generation prompts for the image generation model using the design prompt. A text generation model generates text for one or more text fields in the design template based on the design prompt, and in some embodiments, elements from the design template. In some aspects, the filtering component further evaluates the generated content against the intent embedding, and removes candidates based on their similarity to the user's intent. A document composer arranges the generated and/or found content into a design document, and the system presents the document to the user.

A method, apparatus, non-transitory computer readable medium, and system for document generation are described. One or more aspects of the method, apparatus, non-transitory computer readable medium, and system include obtaining a design prompt that describes a document type; selecting a design template for the document type based on the design prompt; generating, using an image generation model, an image for the design template based on the design prompt; and generating a design document based on the design template, wherein the design document has the document type and includes the image at a location indicated by the design template.

A method, apparatus, non-transitory computer readable medium, and system for document generation are described. One or more aspects of the method, apparatus, non-transitory computer readable medium, and system include obtaining a design prompt that describes a document type; selecting a design template based on the design prompt; generating, using a text generation model, text for the design template based on the design prompt; generating, using an image generation model, an image for the design template based on the design prompt; and generating a design document based on the design template, wherein the design document includes the text and the image.

An apparatus, system, and method for document generation are described. One or more aspects of the apparatus, system, and method include a memory component; a processing device coupled to the memory component; an image generation model comprising parameters stored in the memory component and trained to generate an image for the design document based on the design prompt; and a document composer comprising parameters stored in the memory component and configured to generate a design document based on the image and a design template.

### BRIEF DESCRIPTION OF THE DRAWINGS

FIG. 1 shows an example of a design generation system according to aspects of the present disclosure.

FIG. 2 shows an example of a design generation apparatus according to aspects of the present disclosure.

FIG. 3 shows an example of a guided latent diffusion model according to aspects of the present disclosure.

FIG. 4 shows an example of a U-Net according to aspects of the present disclosure.

FIG. 5 shows an example of a design generation pipeline according to aspects of the present disclosure.

FIG. 6 shows an example of document generation results for the prompt “poster for Halloween movie night” according to aspects of the present disclosure.

FIG. 7 shows an example of document generation results for the prompt “Merry Christmas card from the Johnson family” according to aspects of the present disclosure.

FIG. 8 shows an example of document generation results for the prompt “thank you card” according to aspects of the present disclosure.

FIG. 9 shows an example of a document personalization apparatus according to aspects of the present disclosure.

FIG. 10 shows an example of a design template according to aspects of the present disclosure.

FIG. 11 shows an example of a pipeline for generating style representations according to aspects of the present disclosure.

FIG. 12 shows an example of a pipeline for adjusting a user profile according to aspects of the present disclosure.

FIG. 13 shows an example of user style preferences according to aspects of the present disclosure.

FIG. 14 shows an example of user mood preferences according to aspects of the present disclosure.

FIG. 15 shows an example of a method for generating a design document according to aspects of the present disclosure.

FIG. 16 shows an example of diffusion process according to aspects of the present disclosure.

FIG. 17 shows an example of machine learning training algorithm according to aspects of the present disclosure.

FIG. 18 shows an example of a method for training a diffusion model according to aspects of the present disclosure.

FIG. 19 shows an example of a computing device according to aspects of the present disclosure.

### DETAILED DESCRIPTION

Design documents include visual and textual elements, and blend these elements to convey information, messages, or invitations to a specific audience. These documents often incorporate a range of components, such as images, icons, colors, fonts, and text, arranged thoughtfully on a canvas to achieve a harmonious aesthetic appeal. The versatility of design documents allows them to be used across diverse contexts. They can take the form of informational pamphlets, providing crucial details on a range of topics, flyers announcing events or promoting products and services, or invitations, adding a personal touch to events such as weddings or corporate gatherings.

In some cases, users select from existing templates to save time and resources in generating specific, defined-dimensions designs for different platforms, such as for online social media platforms. A creative workflow for making a design document can involve iteratively adjusting and modifying a design template and tuning each element of the design—from the choice of images, the layout, the color scheme, to the style of text—to better match the purpose of the document.

Conventional methods for design generation are based on search. In some examples, a user provides a query through an input field, and a system provides a set of results that closely match the given query. The user scrolls through the results and selects one of the images for editing as a starting point. If after a series of edits the result is unsatisfactory, the user must begin the process from scratch. For example, when text lengths are changed, a user's initial design may no longer fit or make sense with the text fields in the template, breaking the design.

The iterative editing process can take an extensive amount of time, especially when it involves the manual creation of assets. Further, it is not uncommon for the finalized design document, even after numerous modifications, to not fully embody the creator's initial intent due to the constraints of the template used.

In contrast, present embodiments improve document generation efficiency by generating a full design document from a single design prompt. Embodiments retrieve templates based on their similarity to a user's design prompt, and curate new content for the templates based on the prompt. In this way, systems improve on existing design systems by providing an automatic and end-to-end solution for design creation, reducing the work involved in creating design documents.

The term design prompt refers to a prompt describing a design document. In some examples, the design prompt is a text-only prompt. In some examples, the design prompt could be an image, or a multi-modal prompt that includes text, images, audio data, styles, parameters, or other multi-modal input. In some cases, the design prompt is received from a user. In some cases, input from a user is combined with additional elements (e.g., additional text) to generate the design prompt.

In some cases, a user wishes to see design templates or design documents that have a particular style or mood. Embodiments are configured to personalize a user's experience by retrieving and generating design documents that have a certain style and mood. Style and mood capture many aspects of a design document. Embodiments represent these aspects by encoding both the visual features and the metadata features of the design document or template. Then, trained classifier models label the document with a style category, a style sub-category, and one or more mood categories. In some cases, embodiments further place a user into a “style embedding space” based on the user's interactions with one or more document templates, so that the system may surface templates and documents that better align with the user's affinities.

Embodiments are configured to generate representations for design templates, including representations that capture the style of the design templates and representations that capture the mood of the design templates. Embodiments include a text encoder and an image encoder configured to process a design template's description and image(s), respectively. Some embodiments include separate text encoders and image encoders, e.g., a style-focused text encoder and a mood-focused text encoder, and a style-focused image encoder and a mood-focused image encoder. The encoders may be trained on separate training data so that the representations they generate capture different aspects of the text and of the images. In some cases, the templates include additional textual information, such as topic data, metadata, title, and others.

The encoders generate a style embedding and a mood embedding for each template. Embodiments include a style classifier to classify the style embedding into a style class, and in some cases, an additional style sub-class. Embodiments further include a mood classifier to classify the mood embedding into a mood class, and in some cases, an additional mood sub-class. The classifiers are trained using training data including ground-truth examples of the style and mood classes which are labeled by experts.

Embodiments are further configured to measure user interactions with design templates within a design application. A user profile component aggregates the user interactions and computes a user embedding that represents the user's preferences as a position in a “style space”. The user profile component may additionally determine a mood profile for the user by thresholding the user's interactions with design templates based on the design templates' mood label.

The user's preferences are represented by the user embedding and the user's mood profile. Embodiments improve on existing template search and recommendation systems by creating profiles unique to each user that encode the user's affinities to particular styles of templates and mood, thereby surfacing templates that are more applicable to the user.

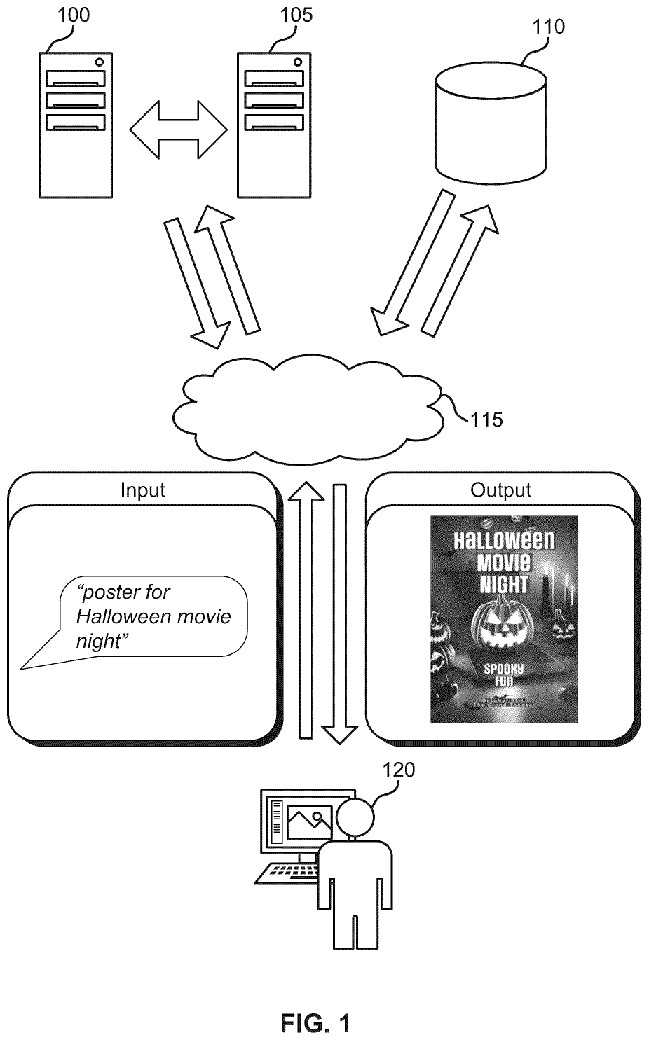

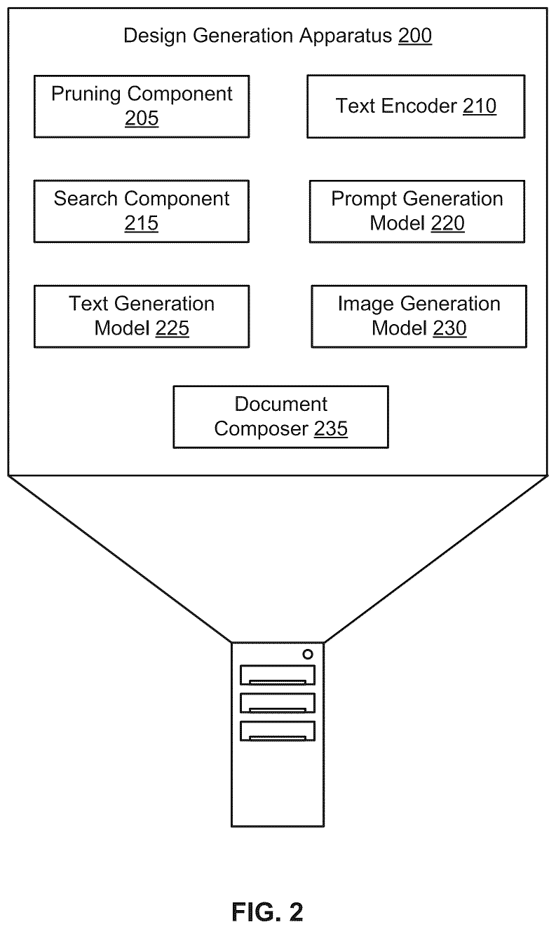

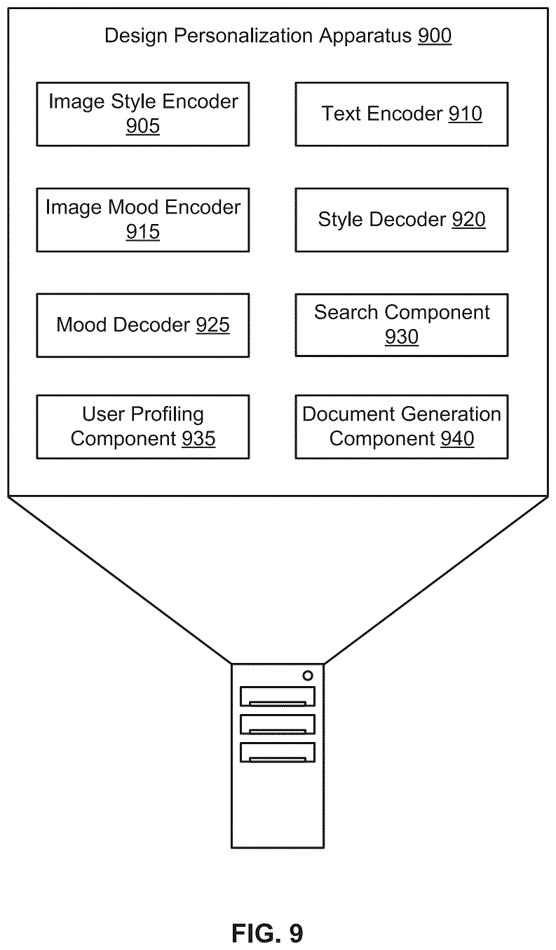

FIG. 1 shows an example of a design generation system according to aspects of the present disclosure. The example shown includes design generation apparatus 100, design personalization apparatus 105, database 110, network 115, and user 120. Design generation apparatus 100 is an example of, or includes aspects of, the corresponding element described with reference to FIG. 2. Design personalization apparatus 105 is an example of, or includes aspects of, the corresponding element described with reference to FIG. 9.

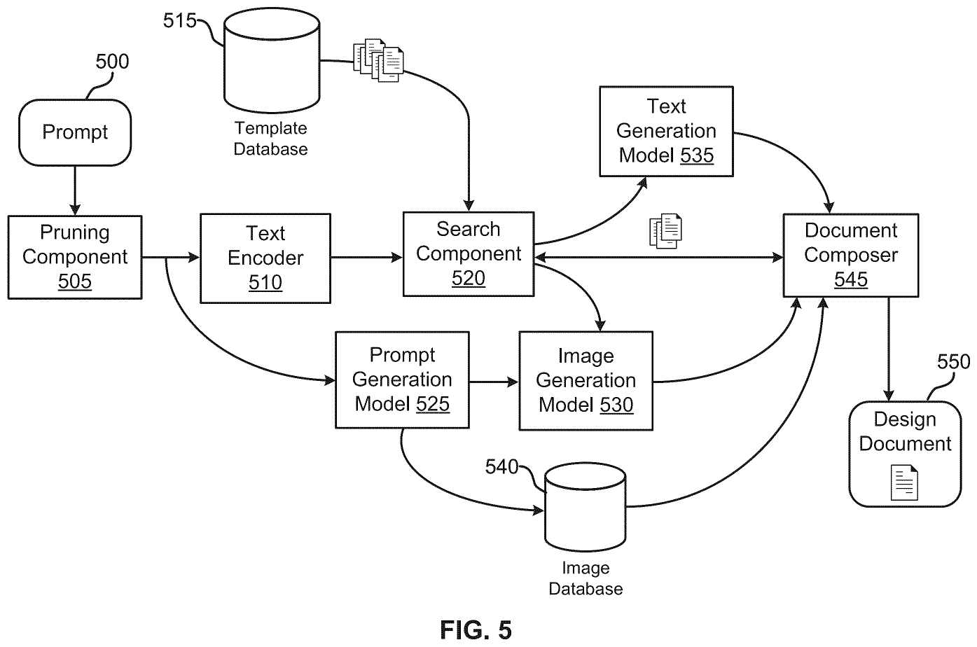

In an example process, a user provides a design prompt to design generation apparatus 100 via user interface 120. Design generation apparatus 100 then processes the user prompt to generate one or more design documents and provides the one or more design documents back to the user. Detail regarding this process will be provided with reference to FIG. 5. In some embodiments, design generation apparatus 100 further personalizes the one or more design documents to the user using style or mood embeddings generated by design personalization apparatus 105.

In some embodiments, one or more components of design generation apparatus 100 and design personalization apparatus 105 are implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a super computer, or any other suitable processing apparatus.

Database 110 is configured to store a plurality of design templates, as well as other data used by the design generation system such as design templates, stock images, generated images, model parameters, style embeddings, mood embeddings, user profile data and user embeddings, and the like. A database is an organized collection of data. For example, a database stores data in a specified format known as a schema. A database may be structured as a single database, a distributed database, multiple distributed databases, or an emergency backup database. In some cases, a database controller may manage data storage and processing in a database. In some cases, a user interacts with a database controller. In other cases, a database controller may operate automatically without user interaction.

Network 115 facilitates the transfer of information between design generation apparatus 100, design personalization apparatus 105, database 110, and a user, e.g. to user interface 120. In some cases, network 115 is referred to as a “cloud”. A cloud is a computer network configured to provide on-demand availability of computer system resources, such as data storage and computing power. In some examples, the cloud provides resources without active management by the user. The term cloud is sometimes used to describe data centers available to many users over the Internet. Some large cloud networks have functions distributed over multiple locations from central servers. A server is designated an edge server if it has a direct or close connection to a user. In some cases, a cloud is limited to a single organization. In other examples, the cloud is available to many organizations. In one example, a cloud includes a multi-layer communications network comprising multiple edge routers and core routers. In another example, a cloud is based on a local collection of switches in a single physical location.

According to some aspects, user interface 120 includes hardware and software configured to display information generated by design generation apparatus 100 and by design personalization apparatus 105 and to receive input from a user. For example, user interface 120 may include a display panel, a keyboard and mouse, a graphical user interface (GUI), and the like.

FIG. 2 shows an example of a design generation apparatus 200 according to aspects of the present disclosure. The example shown includes design generation apparatus 200, pruning component 205, text encoder 210, search component 215, prompt generation model 220, text generation model 225, image generation model 230, and document composer 235.

Design generation apparatus 200 is an example of, or includes aspects of, the corresponding element described with reference to FIG. 1. Pruning component 205 is an example of, or includes aspects of, the corresponding element described with reference to FIG. 5. Text encoder 210 is an example of, or includes aspects of, the corresponding element described with reference to FIGS. 5, 9, and 11.

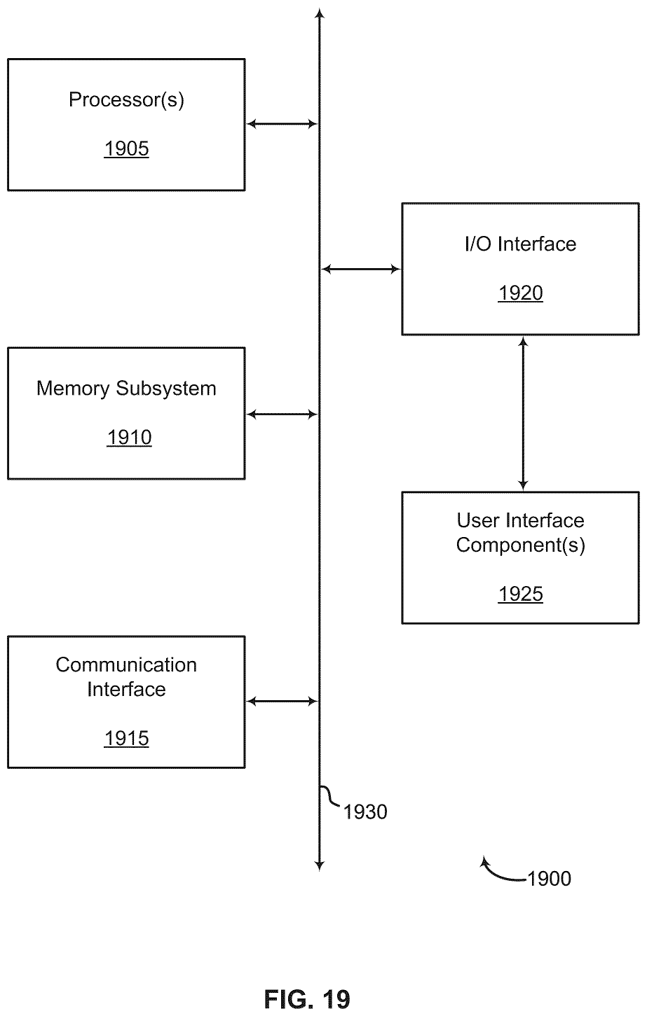

Embodiments of design generation apparatus 200 include several components and sub-components. These components are variously named and are described so as to partition the functionality enabled by the processor(s) and the executable instructions included in the computing device used in design generation apparatus 200 (such as the computing device described with reference to FIG. 19). In some examples, the partitions are implemented physically, such as through the use of separate circuits or processors for each component. In some examples, the partitions are implemented logically via the architecture of the code executable by the processors.

Pruning component 205 is configured to identify one or more extraneous words from a design prompt. In some examples, pruning component 205 removes the one or more extraneous words from the design prompt to obtain a pruned design prompt, where the intent embedding is based on the pruned design prompt. This process is sometimes referred to as “prompt summarization.” In an example, a design prompt includes “I want a poster for ballet classes in Dallas”, and pruning component 205 summarizes this prompt to produce the pruned design prompt “ballet classes in Dallas.” Some examples of pruning component 205 include a language model (LM) such as GPT or Flan-T5. In some aspects, the LM is instructed to summarize the design prompt and to extract these terms. Embodiments are not necessarily limited thereto, however, and some examples of pruning component 205 include a linguistics model configured to perform named entity recognition or part-of-speech techniques on the design prompt. Pruning component 205 is an example of, or includes aspects of, the corresponding element described with reference to FIG. 5.

Text encoder 210 is configured to encode a design prompt to obtain an intent embedding. Embodiments of text encoder 210 include a pre-trained model that is configured to generate a representation vector from a text input. Some examples of the model include a transformer-based model such as sentence-BERT. BERT is short for bi-directional encoder representations from transformers (BERT). BERT is a transformer-based model that is used for natural language processing and for processing other forms of ordered data. In some examples, BERT is used as a language representation model and is configured to pretrain deep bidirectional representations from unlabeled text by jointly conditioning on both left and right context in all layers. As a result, the pre-trained BERT model can be fine-tuned with an additional output layer to create network models for tasks such as question answering and language inference.

BERT is a bi-directional model, meaning that it is able to take into account both the context to the left and right of a given word when processing text. This allows BERT to better understand the relationships between words and their meanings in a given context. BERT can also be fine-tuned for specific tasks by adding additional output layers on top of the pre-trained model. This allows BERT to be tailored to a specific task, such as question answering or language inference, by learning task-specific features from labeled data. Text encoder 210 is an example of, or includes aspects of, the corresponding element described with reference to FIG. 5.

Search component 215 retrieves document templates based on their similarity to the intent embedding. In some cases, the document templates are connected with a template embedding. The template embedding may be generated by encoding a description or title of the document template using an encoder that's the same or similar to the design prompt encoder. According to some aspects, search component 215 selects a design template by filtering a set of design templates based on the intent embedding. In some examples, search component 215 compares the template embedding to the intent embedding to obtain a similarity score, where the design template is selected from the set of design templates based on the similarity score. In some examples, search component 215 identifies one or more template constraints, where the set of design templates is filtered based on the one or more template constraints. In some examples, search component 215 selects the image from a set of images based on the design prompt and the image field of the design template.

Search component 215 is further configured to evaluate image assets of a design template to determine whether or not the images within the template are aligned with the user intent, as represented by the intent embedding. In some embodiments, search component 215 compares an image embedding of an image within a design template to the intent embedding, and filters design templates based on this comparison.

Search component 215 may further filter templates based on other template constraints. Such constraints include: the number of text elements, the length of texts within the text elements, the number of distinct fonts, the number of content images, a measure of how much the content image is obscured by other elements, and others. A content image is an image that contributes information to the template. A blue sky, a closeup of corn, a texture/pattern are considered background images, while images that have distinct elements are considered content images. The classification of an image as content or background is done by an image classifier that includes a vision transformer. The vision transformer may be trained using a set of manually annotated images in the two classes. Search component 215 is an example of, or includes aspects of, the corresponding element described with reference to FIGS. 5 and 9.

Prompt generation model 220 is configured to generate image generation prompts and image search terms based on the design prompt. Embodiments of prompt generation model 220 include an LM such as GPT or Flan-T5. The pruned design prompt may be appended or prepended with prompt engineering instruct the LM to generate text-to-image prompts based on the pruned design prompt. According to some aspects, prompt generation model 220 also generates stock search terms based on the pruned design prompt. In some cases, the text-to-image prompts and the stock search terms are paired, so that when images are curated for a design template, the system creates a generated option and a stock image option, which may then be compared by, e.g., the filtering component, by comparing embeddings of the texts and the images in a common embedding space.

According to some aspects, prompt generation model 220 generates a text generation prompt based on a design prompt and a text field of the design template. In some examples, prompt generation model 220 generates an image generation prompt based on the design prompt and an image field of the design template, where the image is generated based on the image generation prompt. Prompt generation model 220 is an example of, or includes aspects of, the corresponding element described with reference to FIG. 5.

Text generation model 225 is configured to generate new text content for text in a design template. Some embodiments generate the text based on the default text in the template. Some embodiments generate text using only the length of the default text and its semantic role as conditioning. The semantic role of the text is metadata that represents the original purpose of the text, e.g., “title”, “Call to action”, “Location”, or the like. Embodiments of text generation model 225 include an LM such as GPT or Flan-T5.

According to some aspects, text generation model 225 generates text for a text field of the design template based on a text from the design template. According to some aspects, text generation model 225 generates text for a text field of the design template based on the design prompt. Text generation model 225 is an example of, or includes aspects of, the corresponding element described with reference to FIG. 5.

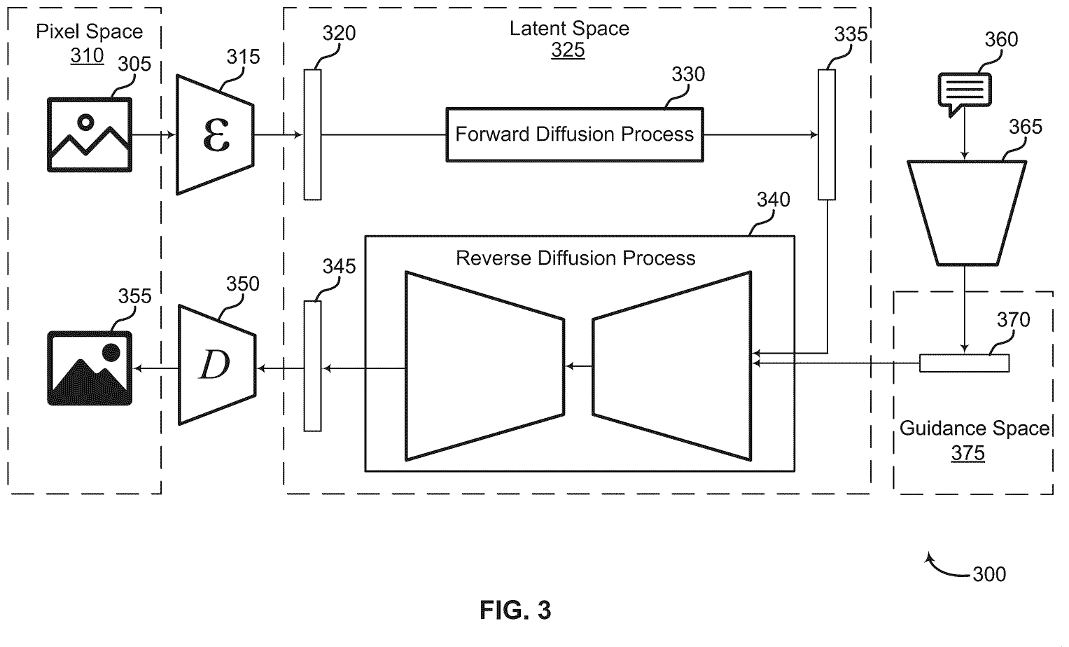

Image generation model 230 generates image content based on the image generation prompts produced by prompt generation model 220. Embodiments of image generation model 230 include a generative model such as a stable diffusion model, though the present disclosure is not limited thereto, and the generative model can be any model that is configured to generated based on a text prompt. According to some aspects, image generation model 230 is configured to generate an image for an image field of the design template based on the design prompt. Some embodiments of image generation model 230 condition image generation based on the default images included in the design template. For example, the system may blur the original images in the design template, and the image generation model 230 may generate images using the blurred image as a condition. In this way, image generation model 230 generates images that have a similar color distribution to the design template image. Image generation model 230 is an example of, or includes aspects of, the guided latent diffusion model described with reference to FIG. 3, and the corresponding element described with reference to FIG. 5.

According to some aspects, document composer 235 generates a design document based on the design template, the text, and the image. Document composer 235 arranges all of the generated texts and images into a design template to produce the final design document that is presented to the user. In some cases, document composer further performs operations such as contrast enhancement and output filtering. For example, document composer 235 may make adjustments to the text if the generated text interferes with the image content, such as length adjustments or content filtering. Document composer 235 may also, for example, direct the image generation model 235 to regenerate images to increase contrast with the text.

Text-related challenges encompass factors such as text size, positioning, and color. When text is too small, visibility is compromised, making it impervious to improvements through color or image editing. In some cases, images, particularly those with intricate patterns, contain an abundance of content, rendering text illegible regardless of its placement. Finally, if the image incorporates contrasting colors beneath the text, readability is compromised, irrespective of the chosen text color. Furthermore, these issues often intersect. In contrast, challenges pertaining to images arise from the difficulty of effectively editing them, often due to user preferences or the inherent characteristics of the photograph. For instance, if a distinctive artistic style has been applied to an image, it can pose a challenge for system to replicate this style accurately. To address such situations, embodiments include a post-processing algorithm designed to identify contrast issues. This algorithm resolves these issues through the application of text effects and recoloring. The algorithm has two phases: the detection phase and the correction phase. Embodiments include two versions of the contrast detection algorithm-a machine-learning-based approach and a computer-vision-based approach. The correction phase offers multiple variations of text effects aimed at enhancing legibility.

The computer vision contrast verification algorithm relies on the bounding box's position, font characteristics, and the actual text content. By considering the text, font, and font size, document composer 235 calculates the average glyph size within the text. Subsequently, the image is cropped according to the text's placement and subdivided into sections of roughly equivalent sizes based on this mean glyph size. This method doesn't require prior text rendering.

An alternative method involves rendering the text first and then adapting the image accordingly. Each resulting section is then analyzed to identify the dominant colors. The system defines a color as dominant if its weight, denoted as “w” within the section, exceeds a predefined hyperparameter “p,” e.g., 10. To evaluate readability compatibility, each color from the color palette is compared to the extracted colors. If there's any contrast mismatch, meaning the contrast ratio exceeds a defined threshold “cₜ,” the color is categorized as incompatible. If all colors within the palette are considered incompatible, the search component 215 may remove the entire design. Document composer 235 is an example of, or includes aspects of, the corresponding element described with reference to FIG. 5.

FIG. 3 shows an example of a guided latent diffusion model 300 according to aspects of the present disclosure. The guided latent diffusion model 300 depicted in FIG. 3 is an example of, or includes aspects of, the image generation model described with reference to FIG. 2.

Diffusion models are a class of generative neural networks which can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (i.e., latent diffusion).

Diffusion models work by iteratively adding noise to the data during a forward process and then learning to recover the data by denoising the data during a reverse process. For example, during training, guided latent diffusion model 300 may take an original image 305 in a pixel space 310 as input and apply and image encoder 315 to convert original image 305 into original image features 320 in a latent space 325. Then, a forward diffusion process 330 gradually adds noise to the original image features 320 to obtain noisy features 335 (also in latent space 325) at various noise levels.

Next, a reverse diffusion process 340 (e.g., a U-Net ANN) gradually removes the noise from the noisy features 335 at the various noise levels to obtain denoised image features 345 in latent space 325. In some examples, the denoised image features 345 are compared to the original image features 320 at each of the various noise levels, and parameters of the reverse diffusion process 340 of the diffusion model are updated based on the comparison. Finally, an image decoder 350 decodes the denoised image features 345 to obtain an output image 355 in pixel space 310. In some cases, an output image 355 is created at each of the various noise levels. The output image 355 can be compared to the original image 305 to train the reverse diffusion process 340.

In some cases, image encoder 315 and image decoder 350 are pre-trained prior to training the reverse diffusion process 340. In some examples, they are trained jointly, or the image encoder 315 and image decoder 350 and fine-tuned jointly with the reverse diffusion process 340.

The reverse diffusion process 340 can also be guided based on a text prompt 260, or another guidance prompt, such as an image (e.g., a blurred version of an image element found in a design template), a layout, a segmentation map, etc. The text prompt 360 can be encoded using a text encoder 365 (e.g., a multimodal encoder) to obtain guidance features 370 in guidance space 375. The guidance features 370 can be combined with the noisy features 335 at one or more layers of the reverse diffusion process 340 to ensure that the output image 355 includes content described by the text prompt 360. For example, guidance features 370 can be combined with the noisy features 335 using a cross-attention block within the reverse diffusion process 340.

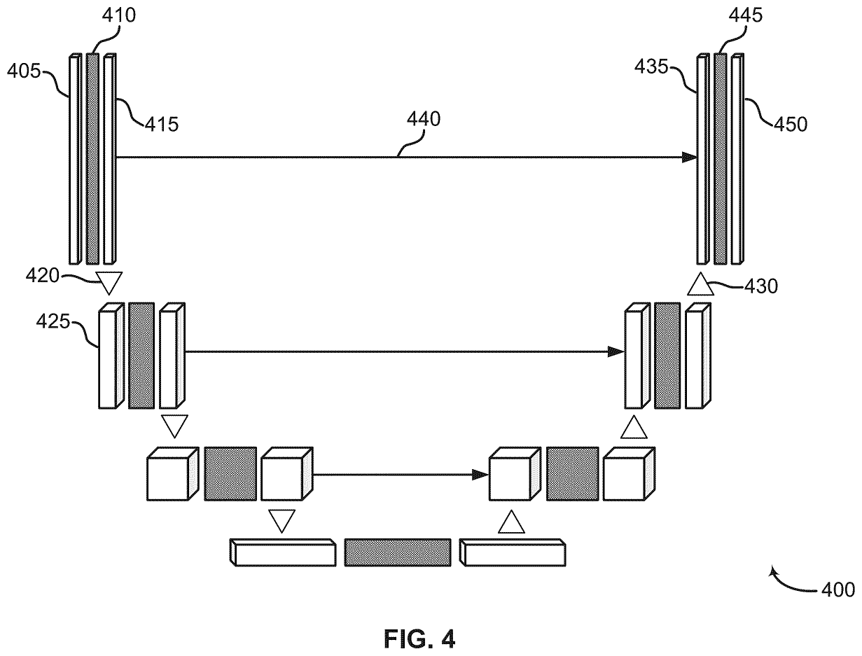

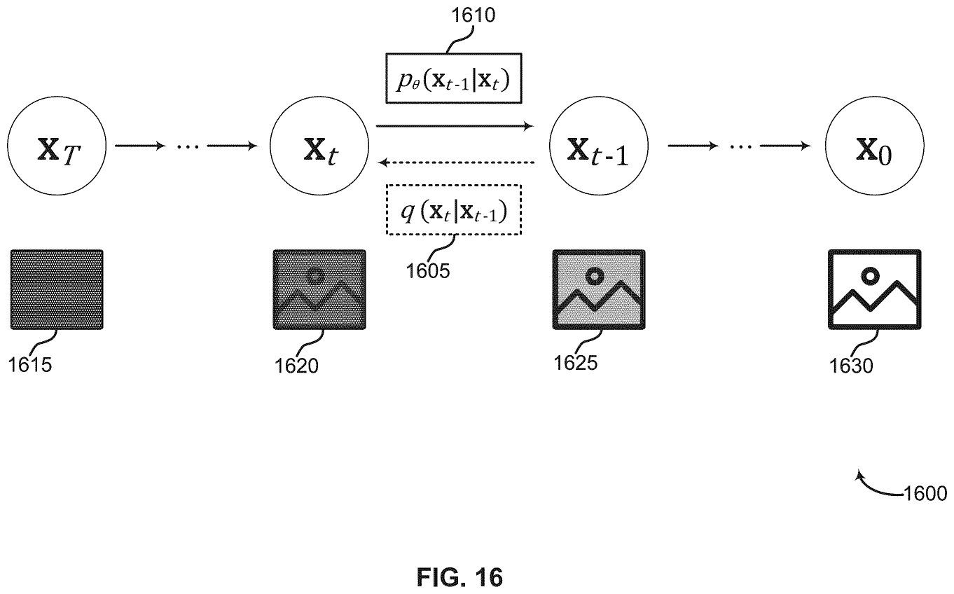

FIG. 4 shows an example of a U-Net 400 according to aspects of the present disclosure. In some examples, U-Net 400 is an example of the component that performs the reverse diffusion process 340 of guided diffusion model 200 described with reference to FIG. 2 and includes architectural elements of the image generation model 230 described with reference to FIG. 2. The U-Net 400 depicted in FIG. 4 is an example of, or includes aspects of, the architecture used within the reverse diffusion process to be described with reference to FIG. 16.

In some examples, diffusion models are based on a neural network architecture known as a U-Net. The U-Net 400 takes input features 405 having an initial resolution and an initial number of channels and processes the input features 405 using an initial neural network layer 410 (e.g., a convolutional network layer) to produce intermediate features 415. The intermediate features 415 are then down-sampled using a down-sampling layer 420 such that down-sampled features 425 have a resolution less than the initial resolution and a number of channels greater than the initial number of channels.

This process is repeated multiple times, and then the process is reversed. That is, the down-sampled features 425 are up-sampled using up-sampling process 430 to obtain up-sampled features 435. The up-sampled features 435 can be combined with intermediate features 415 having the same resolution and number of channels via a skip connection 440. These inputs are processed using a final neural network layer 445 to produce output features 450. In some cases, the output features 450 have the same resolution as the initial resolution and the same number of channels as the initial number of channels.

In some cases, U-Net 400 takes additional input features to produce conditionally generated output. For example, the additional input features could include a vector representation of an input prompt. The additional input features can be combined with the intermediate features 415 within the neural network at one or more layers. For example, a cross-attention module can be used to combine the additional input features and the intermediate features 415.

FIG. 5 shows an example of a design generation pipeline according to aspects of the present disclosure. The example shown includes prompt 500, pruning component 505, text encoder 510, template database 515, search component 520, prompt generation model 525, image generation model 530, text generation model 535, image database 540, document composer 545, and design document 550.

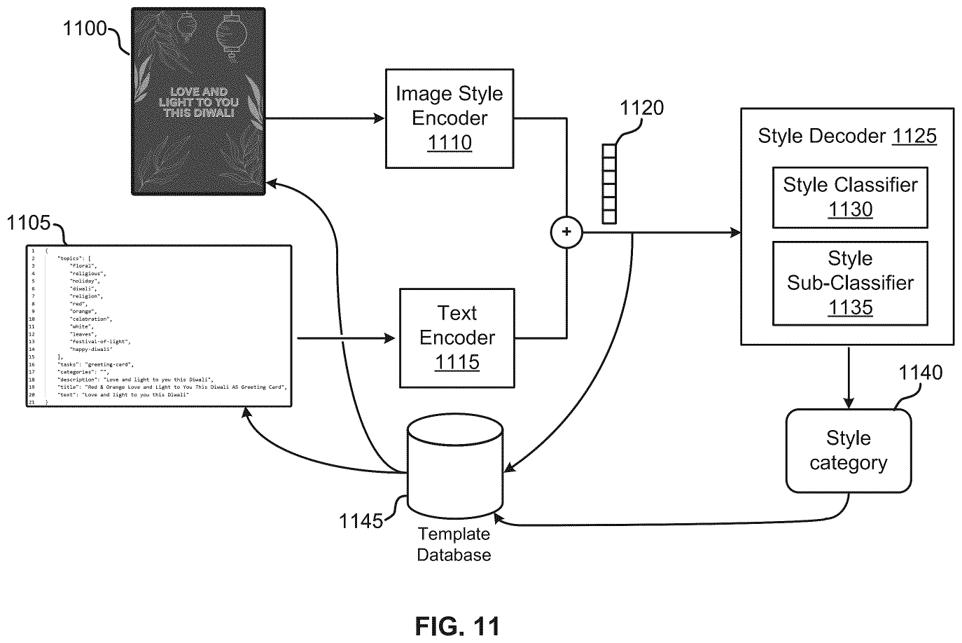

Pruning component 505, prompt generation model 525, image generation model 530, text generation model 535, and composer 545 are examples of, or include aspects of, the corresponding elements described with reference to FIG. 2. Text encoder 510 is an example of, or includes aspects of, the corresponding element described with reference to FIGS. 2, 9, and 11. Template database 515 is an example of, or includes aspects of, the corresponding element described with reference to FIG. 11. Search component 520 is an example of, or includes aspects of, the corresponding element described with reference to FIGS. 2 and 9.

In this example, a user provides prompt 500 such as “I want a poster for ballet classes in Dallas.” Then, pruning component 505 summarizes the prompt by removing extraneous words. For example, the prompt may be summarized to “ballet classes in Dallas”. In some embodiments, the system further extracts a design category, such as “poster”, from prompt 500.

Design prompt encoder 510 encodes the prompt using a text encoder to generate an intent embedding. A search component 520 retrieves design templates from template database 515 and filters these design templates based on their similarity or dissimilarity to the intent embedding, e.g., according to the process described with reference to FIG. 2. The filtering search 520 may compute cosine similarity scores between the intent embedding and a design template embedding and remove the design template as a candidate based on this comparison. According to some aspects, search component 520 also computes cosine similarity scores between the intent embedding and one or more embeddings of the text or image content within the design template and filters the design template based on these comparisons.

Prompt generation model 525 receives the pruned design prompt and generates one or more image generation prompts and one or more stock search terms based on the pruned design prompt. Additional detail regarding the generation of these prompts is provided above with reference to FIG. 2. The system obtains images from an image database using the stock search terms and generates new image content using image generation model 530 and the image generation prompts. In some embodiments, image generation model 530 additionally or alternatively uses the image content from the design template during its generation process. For example, the image generation model may add a blur to existing image content and then condition the generation process on the blurred image, so as to ensure a similar color palette to the original image content in the synthesized image.

The text generation model 535 generates text content based on the text elements within the design template. For example, the text generation model 535 may generate texts based on the length and the semantic role of the default text elements within a design template. The semantic role of the default text elements may be determined by the text generation model 535 or may be defined in a metadata file of the design template, for example.

Document composer 545 then arranges the curated content, i.e., the generated texts and the generated and/or found images into the design template to produce design document 550. In some cases, document composer 545 generates additional variants. The variants may be ranked or removed by search component 520 by, e.g., further comparisons of the curated content to the intent embedding. In some aspects, document composer 545 further performs contrast enhancements or filters profane or inappropriate content before generating the design document 550.

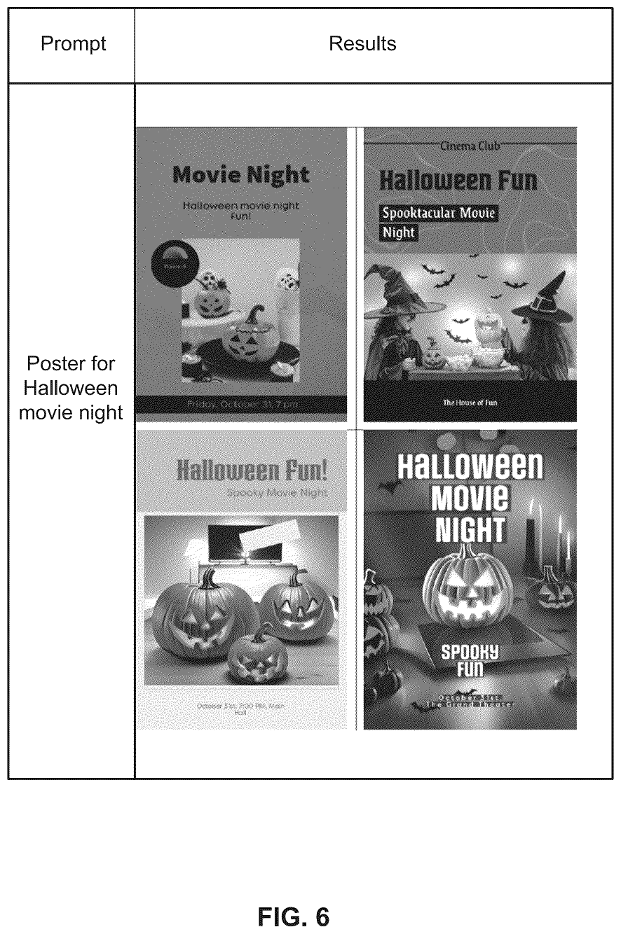

FIG. 6 shows an example of document generation results for the prompt “poster for Halloween movie night” according to aspects of the present disclosure. In the example shown, a user provides a design prompt “poster for Halloween movie night”. The system generates the first examples 600 including customized text and image content based on the design prompt. The results include design documents with multiple text and image elements.

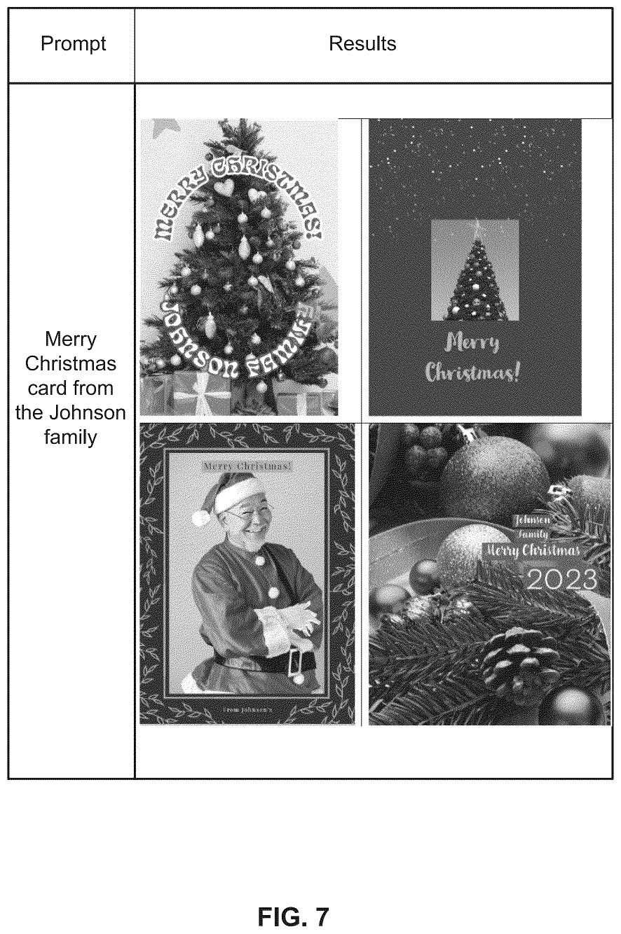

FIG. 7 shows an example of document generation results for the prompt “Merry Christmas card from the Johnson family” according to aspects of the present disclosure. In the example shown, a user provides a design prompt “Merry Christmas card from the Johnson family”. The system generates second examples 700 including customized text and image content based on the design prompt.

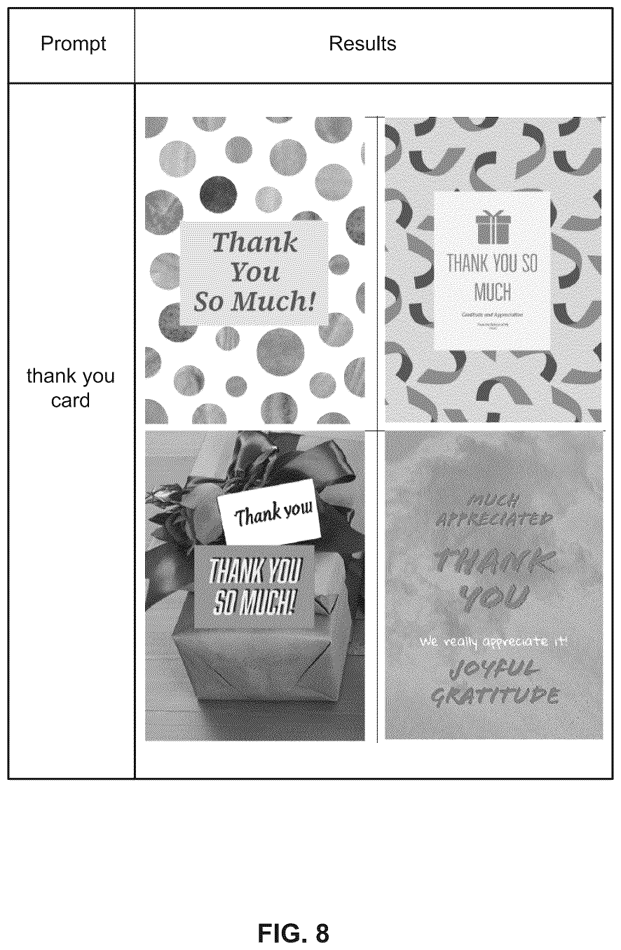

FIG. 8 shows an example of document generation results for the prompt “thank you card” according to aspects of the present disclosure. In the example shown, a user provides a design prompt “Thank you card”. The system generates third examples 800 including customized text and image content based on the design prompt.

FIG. 9 shows an example of a document personalization apparatus according to aspects of the present disclosure. The example shown includes design personalization apparatus 900, image style encoder 905, text encoder 910, image mood encoder 915, style decoder 920, mood decoder 925, search component 930, user profiling component 935, and document generation component 940. The components of FIG. 2 with the same name, such as the text encoder and the search component, may be or be based on similar sets of instructions and/or circuits. For example, the text encoder and the search component may be shared across the apparatuses or may be duplicated and then configured to perform the functionality described with reference to FIG. 9.

Embodiments of design personalization apparatus 900 include several components and sub-components. These components are variously named and are described so as to partition the functionality enabled by the processor(s) and the executable instructions included in the computing device used in design personalization apparatus 900 (such as the computing device described with reference to FIG. 19). In some examples, the partitions are implemented physically, such as through the use of separate circuits or processors for each component. In some examples, the partitions are implemented logically via the architecture of the code executable by the processors.

Image style encoder 905 is configured to generate image style features from one or more images in a design template. In some embodiments, the entire design template is rasterized into a single image, and this image is processed by image style encoder 905 to generate the image style features. Embodiments of image style encoder 905 include a style-focused image encoder such as ALADIN, which is short for “All Layer Adaptive Instance Normalization”. A style focused image encoder is pretrained to generate an embedding that captures stylistic aspects of an image, as contrasted with other features such as structural features. Embodiments of image style encoder 905 are trained to disentangle stylistic features from content features, thereby generating a vector representation of the images that focuses on style.

Text encoder 910 is configured to generate text features of a design template from text information in the design template. In some examples, text encoder 910 encodes text corresponding to each of the set of fields to obtain a set of field embeddings, respectively, where the text features are based on the set of field embeddings. In some examples, text encoder 910 encodes text from metadata of the design template, where the metadata includes information about the design template such as its title, a description of the design template, and its fonts. Embodiments of text encoder 910 include a transformer-based encoder, such as a sentence transformer encoder.

A transformer or transformer network is a type of neural network model used for natural language processing tasks. A transformer network transforms one sequence into another sequence using an encoder and a decoder. Encoder and decoder include modules that can be stacked on top of each other multiple times. The modules comprise multi-head attention and feed forward layers. The inputs and outputs (target sentences) are first embedded into an n-dimensional space. Positional encoding of the different words (i.e., give every word/part in a sequence a relative position since the sequence depends on the order of its elements) are added to the embedded representation (n-dimensional vector) of each word. In some examples, a transformer network includes attention mechanism, where the attention looks at an input sequence and decides at each step which other parts of the sequence are important. The attention mechanism involves query, keys, and values denoted by Q, K, and V, respectively. Q is a matrix that contains the query (vector representation of one word in the sequence), K are all the keys (vector representations of all the words in the sequence) and V are the values, which are again the vector representations of all the words in the sequence. For the encoder and decoder, multi-head attention modules, V consists of the same word sequence than Q. However, for the attention module that is taking into account the encoder and the decoder sequences, V is different from the sequence represented by Q. In some cases, values in V are multiplied and summed with some attention-weights a.

In an example, a design template's design style embedding includes image style features from image style encoder 905 and text features from text encoder 910. The style embedding space may be constructed by combining the dimensions from the image style features and the dimensions from the text features. In one embodiment, each design style embedding for each design template is constructed by concatenating the image style features with the text features. The style embedding can be stored as metadata for each design template. Some embodiments include performing principal component analysis (PCA) the text features from text encoder 910 to yield text features of reduced dimensions, for example, dim size 5.

In some embodiments, style embeddings may be generated for each of multiple design templates in a design template database. When a user provides a query including a prompt for generating a design document, an embedding generated based on the query can be compared to the style embeddings of multiple design templates, and one or more candidate design templates can be selected that match the prompt (e.g., that have the closest distance to a prompt embedding in the style embedding space).

Image mood encoder 915 is configured to generate image mood features from one or more images in a design template. In some embodiments, image mood encoder 915 includes an image encoder that is different from the image encoder used by image style encoder 905. For example, embodiments of image mood encoder 915 include a vision-transformer based model, which performs attention on different regions of an input image to generate the image mood features.

In an example, a design template's design mood embedding includes image mood features from image mood encoder 915 and text features from text encoder 910. The style embedding space may be constructed by combining the dimensions from the image mood features and the dimensions from the text features. In one embodiment, each design mood embedding for each design template is constructed by concatenating the image mood features with the text features.

According to some aspects, style decoder 920 decodes the style embedding to obtain a style category, where the design template is selected based on the style category. In some examples, style decoder 920 identifies a style sub-category based on the style embedding and the style category, where the design template is selected based on the style sub-category. In some aspects, the style decoder 920 is trained based on training data including a training template and a ground-truth style category. Embodiments of style decoder 920 include a style classifier and a style sub-classifier.

For example, the style classifier may include an artificial neural network (ANN) with a plurality of connected layers. The input to the style ANN may include the design style embedding, and the output of the style ANN may include one or more discrete style categories. Examples of style categories include Minimal, Corporate, Elegant, Bold, Organic, Grunge, and Other.

The style sub-classifier may include another ANN-based classifier configured to identify a sub-category of the style category. For example, the style sub-classifier may include a CLIP based model that processes the style category along with the image of the design template to infer a sub-class of the design template. For example, sub-categories of the style category “Minimal” may include “Modern”, “Simple”, “Fresh”, “Contemporary”, etc. Mood decoder 925 may include classifier and sub-classifier models similar to the style decoder 920. The classifier and sub-classifier models may share architectural components but are trained to identify mood classes rather than style classes.

Search component 930 is configured to retrieve design templates from a database based on a user's profile or based on a design prompt including a style class or a mood class. According to some aspects, Search component 930 selects a design template from a set of design templates based on the design prompt and a style embedding of the design template, where the style embedding includes image style features and text features. According to some aspects, user profiling component 935 obtains a user preference embedding associated with the user's profile, where the design template is selected based on the user preference embedding. In some embodiments, the user preference embedding includes a representation of the user's style affinities. The representation of the user's style affinities may be a vector representation based on the user's interaction history with one or more design templates. The vector representation may be of the same dimensionality and/or the same space as a design style embedding. The user preference embedding may further include a representation of the user's mood affinities. In some embodiments, the user's mood affinities are represented by aggregating a user's template interactions, and then choosing one or more mood categories as the user's preferred mood type based on a threshold.

User profiling component 935 generates a user embedding that is a representation of the user's historical actions. For example, user profiling component 935 may obtain a user style embedding, a user mood embedding, or combination thereof by setting the user's initial point in the embedding space to the style or mood embedding of the user's first selected design template, and then update the user style embedding or the user mood embedding based on the user's subsequent choices of design templates. Embodiments of user profiling component 935 are configured to place higher weight on more recent user interactions with design templates. For example, embodiments may utilize an exponentially decaying function. The function enables the determination of style affinity with respect to the most recent interactions. The weights associated with each interaction decay over time, giving way to more recent interactions which will have higher weights, ensuring that the aggregated point representation of a user more heavily relies on the more recent interactions. An example of the decaying function is given by the following equation:

$$decay = exp ( - \frac{i}{\frac{decay half life}{log ( 2 )}} ) \qquad ( 1 )$$

According to some aspects, document generation component 940 generates a design document based on the design template. For example, the document generation component 940 may generate and arrange image and text elements based on the design template to generate the design document. According to some aspects, document generation component 940 performs the same or similar operations as the document composer described with reference to FIG. 2.

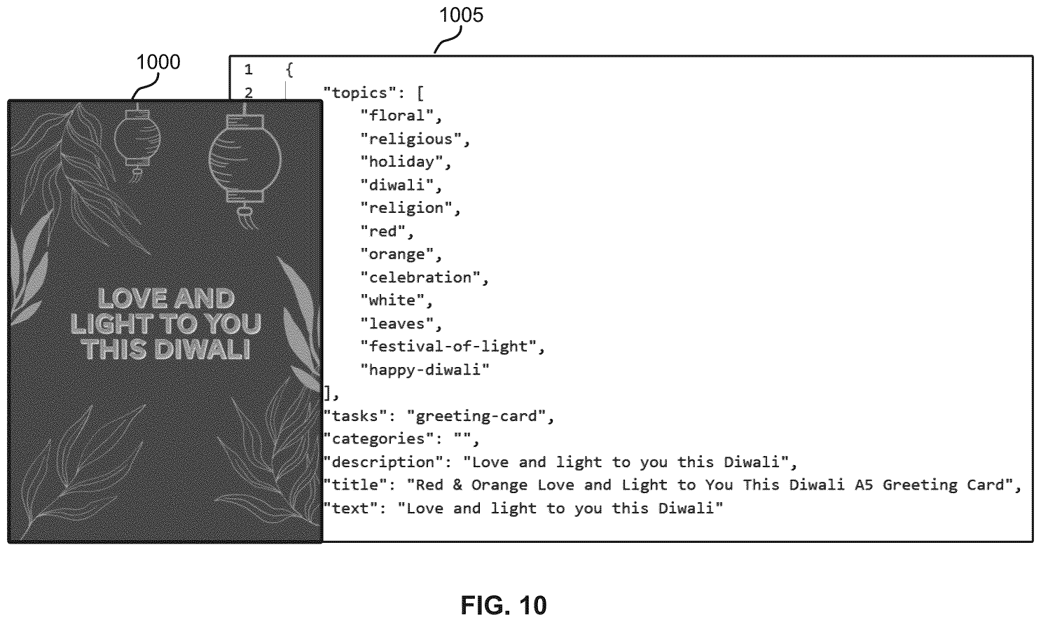

FIG. 10 shows an example of a design template 1000 according to aspects of the present disclosure. The example shown includes design template 1000 and text metadata 1005.

In this example, the design template 1000 includes image content, such as the background image depicting the leaf patterns. The design template 1000 further includes text elements, such as the centered element shown “Love And Light To You This Diwali”. The design template 1000 may have associated text metadata 1005, which describes various properties about the template, and may include items such as a title for the template, a description of the template, fonts used within the template, a design category, and others. In some embodiments, the text metadata 1005 further includes a semantic category for each text element, such as “call to action”, “contact info”, or similar.

FIG. 11 shows an example of a pipeline for generating style representations according to aspects of the present disclosure. The example shown includes design template 1100, metadata 1105, image style encoder 1110, text encoder 1115, design style embedding 1120, style decoder 1125, style category 1140, and template database 1145.

In the example shown, design template 1100 is processed by image style encoder 1110 to generate image style features, and metadata 1105 is processed by text encoder 1115 to generate text features. The image style features and the text features are concatenated to generate design style embedding 1120. This design style embedding can be stored in a template database for later use, e.g., for comparison with a user preference embedding to provide a user with templates that are similar to the user's style affinities.

To generate a style category for the design template, style decoder 1125 processes the design style embedding 1120. In one aspect, style decoder 1125 includes style classifier 1130 and style sub-classifier 1135. As described above, embodiments of style classifier 1130 include an ANN configured to decode design style embedding 1120 to classify the design template to produce style category 1140. Some embodiments further generate a style sub-category, e.g., using style sub-classifier 1135. In some cases, sub-classifier 1135 processes style category 1140 and an image from design template 1100 to generate the style sub-category. According to some aspects, the outputs of the various components in the pipeline may be stored in template database 1145 for use in later operations.

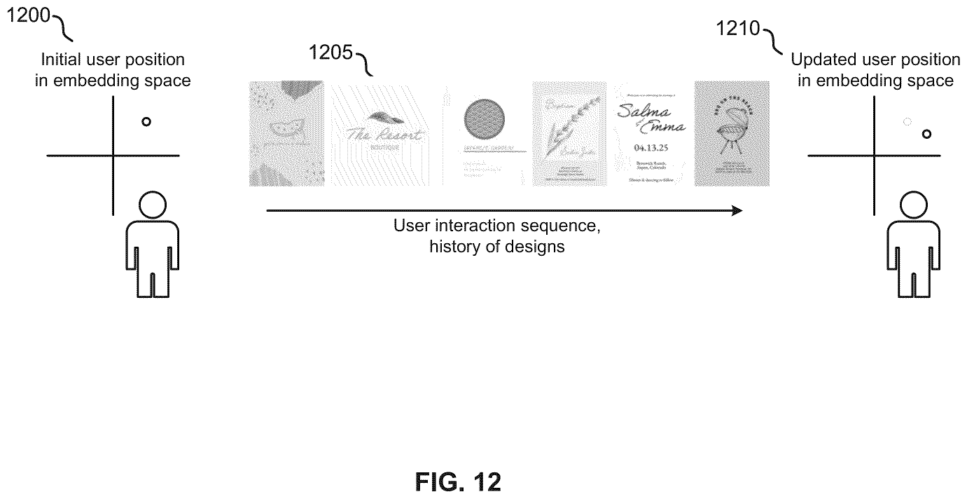

FIG. 12 shows an example of a pipeline for adjusting a user profile according to aspects of the present disclosure. The example shown includes initial user profile 1200, user interaction sequence 1205, and updated user profile 1210.

In this example, a user with initial user profile 1200 provides user interactions 1205 to a design personalization apparatus. The user may provide the user interactions 1205 over many sessions or may provide the user interactions 1205 in a single session, e.g., during a setup phase. Then, the system iteratively adjusts the initial user profile 1200 based on the user interactions 1205. For example, the system may move an embedding of the user within a style space based on the design style embeddings of the design templates that the user interacts with. Though FIG. 12 depicts a two-dimensional user embedding space, embodiments are not limited thereto, and the user embedding space may have a large number of dimensions configured to explicitly or implicitly represent, e.g., style preferences and/or mood preferences. After one or more user interactions, the user's profile is updated user profile 1210. The system may weight more recent user interactions more heavily. In this way, the system is configured to provide templates that are more aligned with an individual user's style affinities.

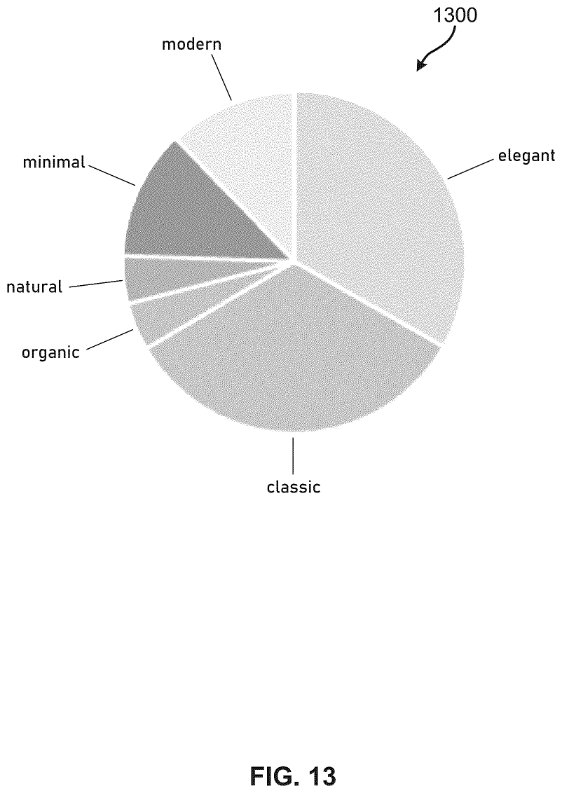

FIG. 13 shows an example of user style preferences according to aspects of the present disclosure. In this example, the user's style profile 1300 includes larger affinities for “elegant” and “classic” styles. The user style preferences may be displayed via a user interface as described with reference to FIG. 1.

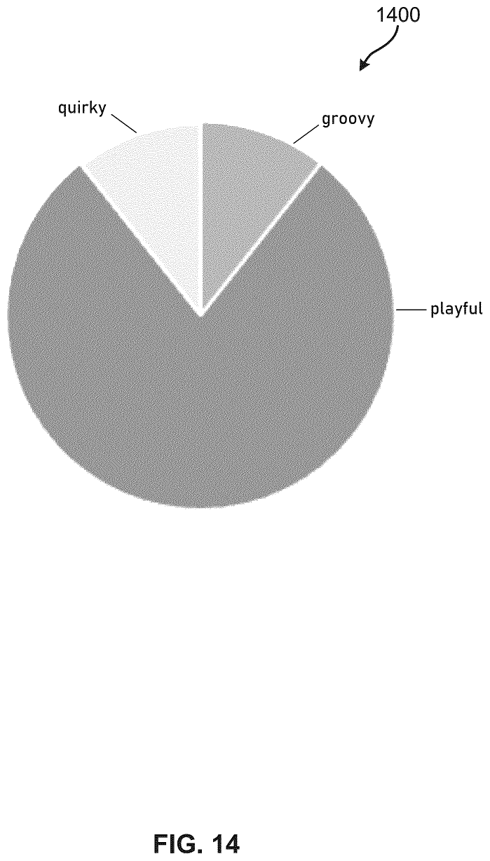

FIG. 14 shows an example of user mood preferences according to aspects of the present disclosure. In this example, the user's mood profile 1400 includes larger affinities for the “playful” mood category. The user mood preferences may be displayed via a user interface as described with reference to FIG. 1.

### Generating Design Documents

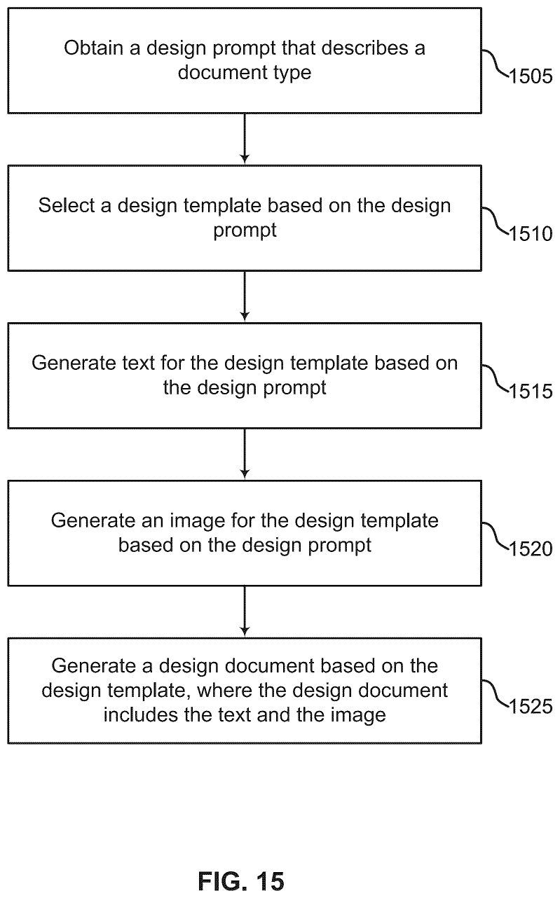

FIG. 15 shows an example of a method 1500 for generating a design document according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 1505, the system obtains a design prompt that describes a document type. In some cases, the operations of this step refer to, or may be performed by or via a user interface described with reference to FIG. 1. The design prompt may be, for example, a user-written text description of a design the user wishes to generate.

At operation 1510, the system selects a design template based on the design prompt. In some cases, the operations of this step refer to, or may be performed by, a search component as described with reference to FIGS. 2, 5, and 9. For example, the system may encode the design prompt to generate an intent embedding, which is a vector representation of the user's intended design. The intent embedding may share an embedding space with the embeddings of the design template. By comparing the intent embedding with embeddings of the design template, the system can select one or more candidate design templates for additional processing.

Optionally, at operation 1515, the system generates text for the design template based on the design prompt. In some cases, the operations of this step refer to, or may be performed by, a text generation model as described with reference to FIGS. 2 and 5. The text generation model may include an LM. In some embodiments, the text generation model generates text based on the design prompt, default text within the design template, design template metadata, or a combination thereof.

At operation 1520, the system generates an image for the design template based on the design prompt. In some cases, the operations of this step refer to, or may be performed by, an image generation model as described with reference to FIGS. 2 and 5. The image generation model may condition its generation based on existing image content within the design template, as well as the intent embedding. For example, the image generation model may incorporate this conditioning by conditioning the generative process using cross-attention as described with reference to FIGS. 3 and 16.

At operation 1525, the system generates a design document based on the design template, where the design document includes the text and the image. In some cases, the operations of this step refer to, or may be performed by, a document composer as described with reference to FIGS. 2 and 5. The document composer may, for example, compare embeddings of the curated text and image contents with the intent embedding to determine if the generated content is sufficiently aligned with the user's intent. When this is not the case, the document composer may instruct the generative models to re-generate content.

FIG. 16 shows a diffusion process 1600 according to aspects of the present disclosure. In some examples, diffusion process 1600 describes an operation of the image generation model 230 described with reference to FIG. 2, such as the reverse diffusion process 340 of guided diffusion model 300 described with reference to FIG. 3.

As described above with reference to FIG. 3, using a diffusion model can involve both a forward diffusion process 1605 for adding noise to an image (or features in a latent space) and a reverse diffusion process 1610 for denoising the images (or features) to obtain a denoised image. The forward diffusion process 1605 can be represented as q(xₜ|xₜ₋₁), and the reverse diffusion process 1610 can be represented as p(xₜ₋₁|xₜ). In some cases, the forward diffusion process 1605 is used during training to generate images with successively greater noise, and a neural network is trained to perform the reverse diffusion process 1610 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 1610, the model begins with noisy data x_{T}, such as a noisy image 1615 and denoises the data to obtain the p(xₜ₋₁|xₜ). At each step t−1, the reverse diffusion process 1610 takes xₜ, such as first intermediate image 1620, and t as input. Here, t represents a step in the sequence of transitions associated with different noise levels, The reverse diffusion process 1610 outputs xₜ₋₁, such as second intermediate image 1625 iteratively until x_{T} reverts back to x₀, the original image 1630. The reverse process can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) \qquad ( 2 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) \qquad ( 3 )$$

where p(x_{T})=N(x_{T}; 0, l) is the pure noise distribution as the reverse process takes the outcome of the forward process, a sample of pure noise, as input and Πₜ₌₁^{T}p_{θ}(xₜ₋₁|xₜ) represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input image with low image quality, latent variables x₁, . . . , x_{T} represent noisy images, and \tilde{x} represents the generated image with high image quality.

### Training Techniques

In some embodiments, pretrained models such as text encoders, image encoders, and image generation model(s) are additionally trained (i.e., “finetuned”) to generate data that better aligns with design document generation. Embodiments may, for example, finetune text models to generate text that is more appropriate for design document contexts, or images with reduced realism and increased vector-like attributes, such as flatter colors.

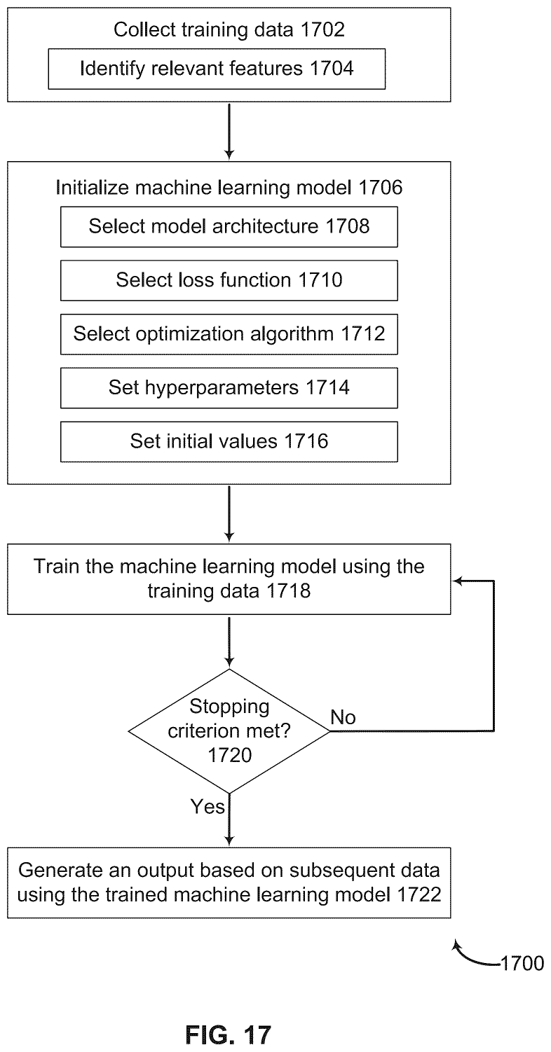

FIG. 17 is a flow diagram depicting an algorithm as a step-by-step procedure 1700 in an example implementation of operations performable for training a machine-learning model. In some embodiments, the procedure 1700 describes an operation of a training component for configuring the image generation model 230 as described with reference to FIG. 2. Such a training component may be, for example, implemented on an additional apparatus other than the design generation apparatus or the design personalization apparatus. The procedure 1700 provides one or more examples of generating training data, use of the training data to train a machine-learning model, and use of the trained machine-learning model to perform a task.

To begin in this example, a machine-learning system collects training data (block 1702) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1704) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 1706). Initialization of the machine-learning model includes selecting a model architecture (block 1708) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1710). The loss function is utilized to measure a difference between an output of the machine-learning model (i.e., predictions) and target values (e.g., as expressed by the training data) to be used to train the machine-learning model. Additionally, an optimization algorithm is selected (1712) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1714) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1718) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1720), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1720), the procedure 1700 continues training of the machine-learning model using the training data (block 1718) in this example.

If the stopping criterion is met (“yes” from decision block 1720), the trained machine-learning model is then utilized to generate an output based on subsequent data (block 1722). The trained machine-learning model, for instance, is trained to perform a task as described above and therefore once trained is configured to perform that task based on subsequent data received as an input and processed by the machine-learning model.

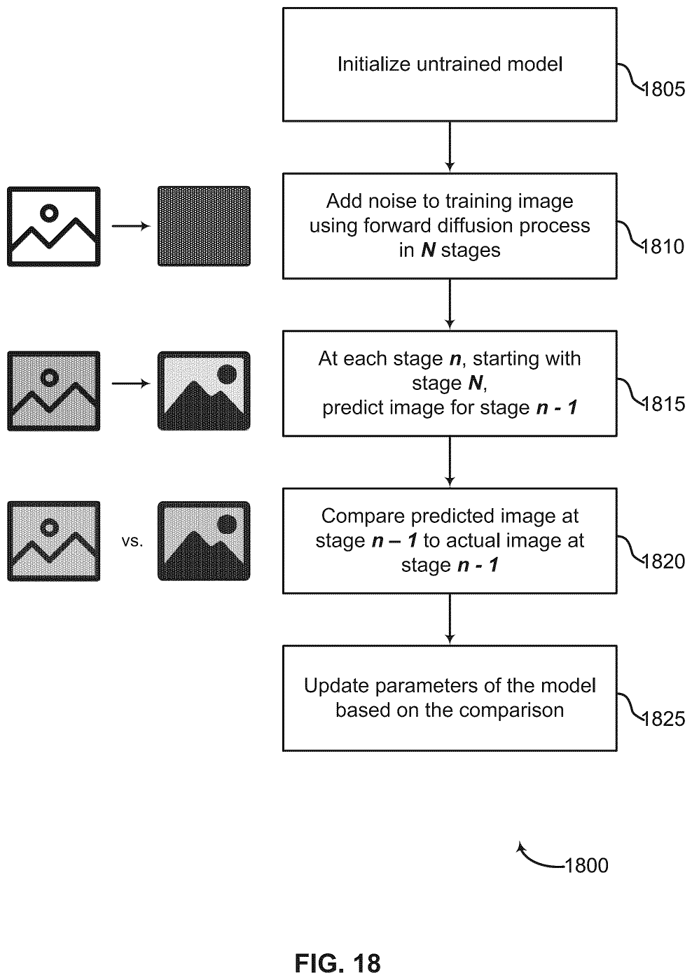

FIG. 18 shows an example of a method 1800 for training a diffusion model according to aspects of the present disclosure. In some embodiments, the method 1800 describes an operation of a training component that may be used to configure the image generation model 230 as described with reference to FIG. 2. The method 1800 represents an example for training a reverse diffusion process as described above with reference to FIG. 16. In some examples, these operations are performed by a system including a processor executing a set of codes to control functional elements of an apparatus, such as the guided diffusion model described in FIG. 3.

Additionally or alternatively, certain processes of method 1800 may be performed using special-purpose hardware. Generally, these operations are performed according to the methods and processes described in accordance with aspects of the present disclosure. In some cases, the operations described herein are composed of various substeps or are performed in conjunction with other operations.

At operation 1805, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1810, the system adds noise to a training image using a forward diffusion process in N stages. In some cases, the forward diffusion process is a fixed process where Gaussian noise is successively added to an image. In latent diffusion models, the Gaussian noise may be successively added to features in a latent space.

At operation 1815, the system at each stage n, starting with stage N, a reverse diffusion process is used to predict the image or image features at stage n−1. For example, the reverse diffusion process can predict the noise that was added by the forward diffusion process, and the predicted noise can be removed from the image to obtain the predicted image. In some cases, an original image is predicted at each stage of the training process.

At operation 1820, the system compares predicted image (or image features) at stage n−1 to an actual image (or image features), such as the image at stage n−1 or the original input image. For example, given observed data x, the diffusion model may be trained to minimize the variational upper bound of the negative log-likelihood-log pe (x) of the training data.

At operation 1825, the system updates parameters of the model based on the comparison. For example, parameters of a U-Net may be updated using gradient descent. Time-dependent parameters of the Gaussian transitions can also be learned.

FIG. 19 shows an example of a computing device 1900 according to aspects of the present disclosure. The example shown includes computing device 1900, processor(s) 1905, memory subsystem 1910, communication interface 1915, I/O interface 1920, user interface component(s), and channel 1930.

In some embodiments, computing device 1900 is an example of, or includes aspects of, the design generation apparatus 200 of FIG. 2, or the design personalization apparatus of FIG. 9. In some embodiments, computing device 1900 includes one or more processors 1905 are configured to execute instructions stored in memory subsystem 1910 to obtain a design prompt that describes a document type; select a design template based on the design prompt; generate, using a text generation model, text for the design template based on the design prompt; generate, using an image generation model, an image for the design template based on the design prompt; and generate a design document based on the design template, wherein the design document includes the text and the image.

According to some aspects, computing device 1900 includes one or more processors 1905. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1910 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. The memory may store various parameters of machine learning models used in the components described with reference to FIG. 2. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1915 operates at a boundary between communicating entities (such as computing device 1900, one or more user devices, a cloud, and one or more databases) and channel 1930 and can record and process communications. In some cases, communication interface 1915 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1920 is controlled by an I/O controller to manage input and output signals for computing device 1900. In some cases, I/O interface 1920 manages peripherals not integrated into computing device 1900. In some cases, I/O interface 1920 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1920 or via hardware components controlled by the I/O controller.

According to some aspects, user interface component(s) 1925 enable a user to interact with computing device 1900. In some cases, user interface component(s) 1925 include an audio device, such as an external speaker system, an external display device such as a display screen, an input device (e.g., a remote-control device interfaced with a user interface directly or through the I/O controller), or a combination thereof. In some cases, user interface component(s) 1925 include a GUI, such as the one described with reference to FIG. 1. Accordingly, the present disclosure includes the following aspects.

A method for document generation is described. One or more aspects of the method include obtaining a design prompt that describes a document type; selecting a design template based on the design prompt; generating, using a text generation model, text for the design template based on the design prompt; generating, using an image generation model, an image for the design template based on the design prompt; and generating a design document based on the design template, wherein the design document includes the text and the image.

Some examples of the method, apparatus, non-transitory computer readable medium, and system further include identifying one or more extraneous words from the design prompt. Some examples further include removing the one or more extraneous words from the design prompt to obtain a pruned design prompt, wherein the intent embedding is based on the pruned design prompt.

Some examples of the method, apparatus, non-transitory computer readable medium, and system further include encoding the design prompt to obtain an intent embedding. Some examples further include encoding the design template to obtain a template embedding. Some examples further include comparing the template embedding to the intent embedding to obtain a similarity score, wherein the design template is selected from the plurality of design templates based on the similarity score.

Some examples of the method, apparatus, non-transitory computer readable medium, and system further include generating an image generation prompt based on the design prompt and the image field of the design template, wherein the image is generated based on the image generation prompt. Some examples further include identifying a style embedding of the design template, wherein the style embedding comprises image style features and text features, and wherein the design template is selected based on the style embedding. Some examples further include concatenating the image style features and the text features to obtain the style embedding.

Some examples of the method, apparatus, non-transitory computer readable medium, and system further include obtaining a user preference embedding, wherein the design template is selected based on the user preference embedding. Some examples further include encoding an image of the design template to obtain a mood embedding, wherein the design template is selected based at least in part on the embedding.

A method for document generation is described. One or more aspects of the method include obtaining a design prompt that describes a document type; selecting a design template based on the design prompt; generating, using a text generation model, text for the design template based on the design prompt; generating, using an image generation model, an image for the design template based on the design prompt; and generating a design document based on the design template, wherein the design document includes the text and the image.

Some examples of the method, apparatus, non-transitory computer readable medium, and system further include encoding the design prompt to obtain an intent embedding. Some examples further include encoding the design template to obtain a template embedding. Some examples further include comparing the template embedding to the intent embedding to obtain a similarity score, wherein the design template is selected from the plurality of design templates based on the similarity score.

Some examples of the method, apparatus, non-transitory computer readable medium, and system further include computing a style embedding of the design template, wherein the style embedding comprises image style features concatenated to text features, and wherein the design template is selected based on the style embedding. Some examples further include obtaining a user preference embedding, wherein the design template is selected based on the user preference embedding. Some examples further include encoding an image of the design template to obtain a mood embedding, wherein the design template is selected based at least in part on the embedding.

An apparatus for document generation is described. One or more aspects of the apparatus include at least one processor; at least one memory storing instructions executable by the at least one processor; a search component configured to select a design template based on a design prompt; and a document composer configured to generate a design document based on the design template, a text, and the image, wherein the text and the image are obtained based on the design prompt.

Some examples of the apparatus, system, and method further include a text encoder configured to encode the design prompt to obtain an intent embedding. Some examples further include a text generation model configured to text for the design template. Some examples further include an image generation model configured to generate an image for the design template. Some examples further include an image style encoder configured to generate image style features. Some examples further include a text style encoder configured to generate text features. Some examples further include a style decoder configured to decode the image style features and the text features to obtain a style category. In some aspects, the search component selects the design template based on the style category.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining a design prompt that describes a document type;
selecting a design template for the document type based on the design prompt;
generating, using an image generation model, an image for the design template based on the design prompt; and
generating a design document based on the design template, wherein the design document has the document type and includes the image at a location indicated by the design template.

2. The method of claim 1, further comprising:
generating, using a text generation model, text for the design template based on the design prompt, wherein the design document includes the text at a location determined according to the design template.

3. The method of claim 1, wherein selecting the design template comprises:
encoding the design prompt to obtain an intent embedding;
encoding the design template to obtain a template embedding; and
comparing the template embedding to the intent embedding to obtain a similarity score, wherein the design template is selected from the plurality of design templates based on the similarity score.

4. The method of claim 1, wherein generating the image comprises:
generating an image generation prompt based on the design prompt and the image field of the design template, wherein the image is generated based on the image generation prompt.

5. The method of claim 1, further comprising:
identifying a style embedding of the design template, wherein the style embedding comprises image style features and text features, and wherein the design template is selected based on the style embedding.

6. The method of claim 5, further comprising:
concatenating the image style features and the text features to obtain the style embedding.

7. The method of claim 1, wherein selecting the design template comprises:
obtaining a user preference embedding, wherein the design template is selected based on the user preference embedding.

8. The method of claim 1, wherein selecting the design template comprises:
encoding an image of the design template to obtain a mood embedding, wherein the design template is selected based at least in part on the embedding.

9. A non-transitory computer readable medium storing code for image processing, the code comprising instructions that, when executed by at least one processor, cause the at least one processor to perform operations comprising:
obtaining a design prompt that describes a document type;
selecting a design template based on the design prompt;
generating, using a text generation model, text for the design template based on the design prompt;
generating, using an image generation model, an image for the design template based on the design prompt; and
generating a design document based on the design template, wherein the design document includes the text and the image.

10. The non-transitory computer readable medium of claim 9, the code further comprising instructions that, when executed by the at least one processor, cause the at least one processor to perform operations comprising:
encode the design prompt to obtain an intent embedding;
encode the design template to obtain a template embedding; and
compare the template embedding to the intent embedding to obtain a similarity score, wherein the design template is selected from the plurality of design templates based on the similarity score.

11. The non-transitory computer readable medium of claim 9, the code further comprising instructions that, when executed by the at least one processor, cause the at least one processor to perform operations comprising:
compute a style embedding of the design template, wherein the style embedding comprises image style features concatenated to text features, and wherein the design template is selected based on the style embedding.

12. The non-transitory computer readable medium of claim 9, the code further comprising instructions that, when executed by the at least one processor, cause the at least one processor to perform operations comprising:
obtain a user preference embedding, wherein the design template is selected based on the user preference embedding.

13. The non-transitory computer readable medium of claim 9, the code further comprising instructions that, when executed by the at least one processor, cause the at least one processor to perform operations comprising:
encode an image of the design template to obtain a mood embedding, wherein the design template is selected based at least in part on the embedding.

14. A system comprising:
a memory component;
a processing device coupled to the memory component;
an image generation model comprising parameters stored in the memory component and trained to generate an image for the design document based on the design prompt; and
a document composer comprising parameters stored in the memory component and configured to generate a design document based on the image and a design template.

15. The system of claim 14, further comprising:
a text encoder configured to encode the design prompt to obtain an intent embedding.

16. The system of claim 14, further comprising:
a text generation model comprising parameters stored in the memory component and trained to generate text for a design document based on a design prompt.

17. The system of claim 14, further comprising:
the image generation model comprises a diffusion model.

18. The system of claim 14, further comprising:
an image style encoder configured to generate image style features; and
a text style encoder configured to generate text features.

19. The system of claim 18, further comprising:
a style decoder configured to decode the image style features and the text features to obtain a style category.

20. The system of claim 19, wherein:
the search component selects the design template based on the style category.
